(19) United States
(12) Patent Application Publication
(10) Pub. No.: US 2009/0121442 A1
(43) Pub. Date: May 14, 2009

(54) METHOD OF MANUFACTURING RING-SHAPED MEMBER, BACKUP RING AND SEAL STRUCTURE FOR FUEL INJECTION VALVE

(76) Inventors: Yasufumi Uozumi, Saitama (JP); Eiji Mochizuki, Nagano (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/094,453

(22) PCT Filed: Nov. 27, 2006
(86) PCT No.: PCT/JP2006/323548

§ 371 Date: May 21, 2008

(30) Foreign Application Priority Data
Dec. 16, 2005 (JP) 2005 362714

(51) Int. Cl. F16J 15/34; B26F 1/40; F02M 61/16

(52) U.S. Cl. 277/381; 83/30

(57) ABSTRACT

To provide: a method of manufacturing a ring-shaped member that can efficiently manufacture a stronger backup ring that reinforces a seal member disposed in a pressure introduction chamber of a fuel injection valve; the backup ring; and a seal structure for a fuel injection valve disposed with the backup ring.

A method of manufacturing a ring-shaped member that is manufactured by subjecting a rigid flat-shaped base material to burring includes: a step of forming a prepared hole with respect to the base material; a step of pressing an edge portion of the prepared hole to thereby bend the edge portion using a first punch member that has a diameter that is larger than the diameter of the prepared hole and is tapered towards its distal end portion; and a step of forming a flange portion by press-inserting, with respect to the prepared hole whose edge portion has been bent, a second punch member that has a diameter that is smaller than the diameter of the first punch member and is tapered towards its distal end portion.

### TECHNICAL FIELD

The present invention relates to a method of manufacturing a ring-shaped member, a backup ring, and a seal structure for a fuel injection valve. In particular, the present invention relates to a method of manufacturing a ring-shaped member suited for a backup ring used in a fuel injection valve that injects, at a predetermined timing, high-pressure fuel supplied from a pressure accumulator (common rail) or the like, a backup ring manufactured by the method of manufacturing a ring-shaped member, and a seal structure for a fuel injection valve using the backup ring.

### BACKGROUND ART

Conventionally, in a fuel injection system of an internal combustion engine, a fuel injection valve for supplying fuel to cylinders of the internal combustion engine is given a configuration that mainly includes an injector housing, a nozzle body, a nozzle needle, a valve piston, a valve body, a back pressure control component, and a connecting rod. Additionally, when the fuel injection system is disposed with a pressure accumulator (common rail), high-pressure fuel that has been pressure-fed at a high pressure by a fuel pump from a fuel tank is accumulated in the common rail (pressure accumulator), supplied to the fuel injection valve from the connecting rod, and becomes capable of being injected when a fuel injection hole formed in a distal end portion of the nozzle body has been opened.

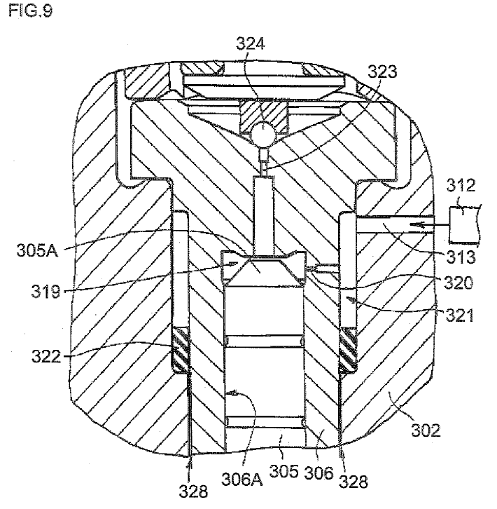

FIG. 9 shows an enlarged cross-sectional diagram of relevant portions of the valve body and the back pressure control component in such a fuel injection valve. As shown in FIG. 9, a control pressure chamber 319 is formed in an upper central portion of a valve body 306, and a distal end portion of a valve piston 305 is allowed to face the control pressure chamber 319 from below. The control pressure chamber 319 is communicated with an introduction-side orifice 320 formed in the valve body 306. The introduction-side orifice 320 is communicated with a fuel passage 313 via a pressure introduction chamber 321 formed between the valve body 306 and an injector housing 302 and supplies pressure introduced from a common rail 312 to the control pressure chamber 319. A seal member 322 comprising a resin material, a rubber material, a copper material, or another soft material is disposed in a lower end portion of the pressure introduction chamber 321, and a high pressure side of the pressure introduction chamber 321 and a low pressure side (gap 328) between the injector housing 302 and the valve body 306 are cut off from each other by the seal member 322.

In such a fuel injector valve, the fuel pressure in the pressure introduction chamber 321 is equal to the injection pressure because it becomes present in an entrance portion leading to the control pressure chamber 319 that controls the fuel injection amount from the injection hole (not shown) and the injection period, and high pressure that is the equal to the injection pressure acts on the seal member 322. On the other hand, a clearance that allows axial direction sliding of the valve piston 305 that integrally moves with the nozzle needle (not shown) is needed between the valve piston 305 and the valve body 306. When a structure is employed where the valve body 306 is press-inserted inside the injector housing 302, there is the potential for the valve body 306 to deform slightly inward and obstruct the sliding of the valve piston 305, so a slight gap 328 is also disposed between the injector housing 302 and the valve body 306. Consequently, there is the potential for part of the seal member 322 to end up being pressed out in the gap 328 (low pressure side) between the injector housing 302 and the valve body 306 by high pressure in the pressure introduction chamber 321.

Moreover, when part accuracy, eccentricity, or requirements during assembly are compounded, there is also the potential for the seal member 322 to be pressed out in the direction of the gap 328 so that the seal member becomes unable to retain its seal function. Because of such a drop in seal function, there is the potential for this to lead not only to a shift in the injection timing in the back pressure control component (not shown) and a drop in responsiveness but also a drop in the lifespan of the fuel injection valve (not shown).

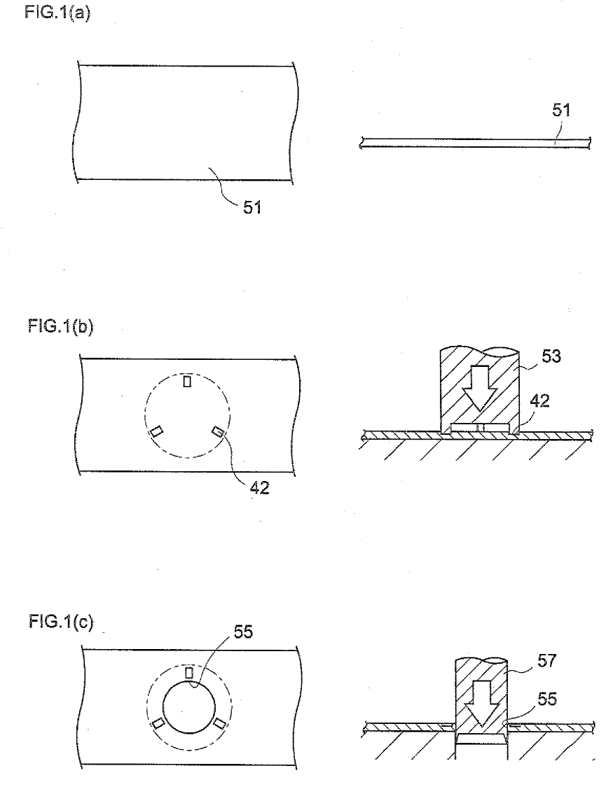

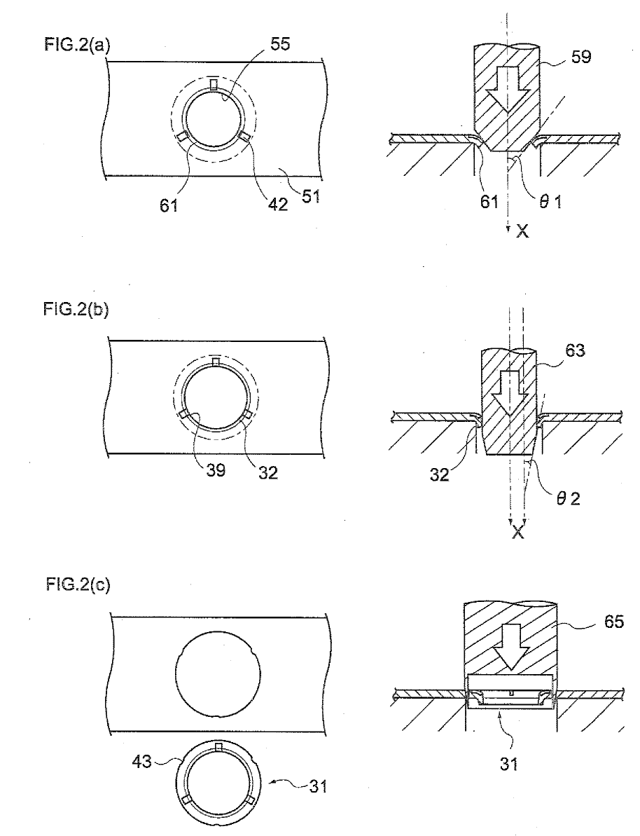

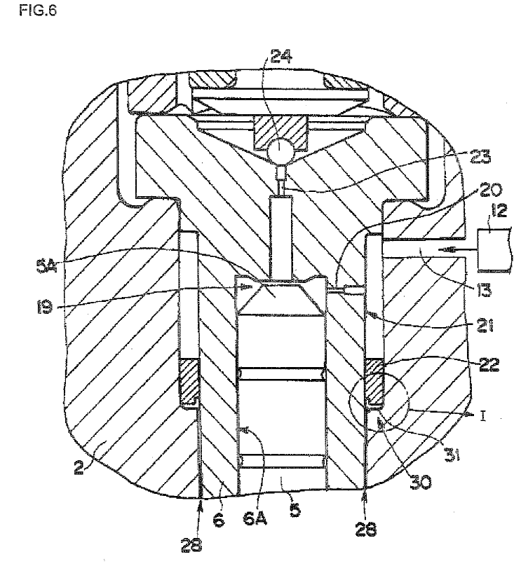

Thus, a seal structure for a fuel injection valve has been disclosed which improves the seal function in the pressure introduction chamber of the fuel injection valve, improves the durability and lifespan of the seal member and the fuel injection valve, stabilizes the seal function, and can be inexpensively manufactured without excessively requiring part accuracy. More specifically, as shown in FIG. 6, this is a seal structure for a fuel injection valve 1 where a seal member 22 is disposed in a high-pressure pressure introduction chamber 21 between an injector housing 2 and a valve body 6 into which a valve piston 5 has been slidably inserted, such that the seal member 22 seals the space between the pressure introduction chamber 21 and a low pressure side (gap 28), wherein a support ring (backup ring) 31 is disposed on the low pressure side of the seal member 22 (see Patent Document 1). Patent Document 1: JP-A-2003-28021 (FIG. 1 and FIG. 2)

### DISCLOSURE OF THE INVENTION

### Problem that the Invention is to Solve

However, in recent years, the pressure of fuel supplied by common rail systems is being raised, and internal pressure fluctuates in accompaniment with fuel injection and the like, so in the backup ring disposed in the fuel injection valve described in Patent Document 1, there has been the potential for the backup ring to be damaged by the high pressure of a fuel chamber formed between the backup ring and a seal ring. With respect thereto, it is thought that making the thickness of the backup ring thicker is effective in order to raise the strength of the backup ring, but that extrusion of the seal ring occurs because the height of a flange portion of the backup ring cannot be ensured when the thickness is ensured. That is, the backup ring used in the fuel injection valve is extremely small and manufactured by burring, but because its bending stress becomes larger when its thickness is thick, it becomes difficult for the backup ring to deform when it is subjected to burring, so it becomes difficult to ensure its height. On the other hand, when its height is ensured while pressing excessively and working the material, there is also the problem that the thickness of the flange portion to be formed becomes thin, its strength drops, and in extreme cases the flange portion ends up breaking.

Thus, the inventors of the present invention made dedicated efforts and discovered that, by subjecting a base material to bending a predetermined extent beforehand at a stage prior to performing burring as a finishing process, both the thickness and height of the flange portion can be ensured even when the thickness of the base material is relatively thick and that this problem can be solved, and completed the present invention.

That is, it is an object of the present invention to provide a method of manufacturing a ring-shaped member such as a backup ring that can ensure, to a predetermined extent or more, both the thickness and height of a flange portion and can improve its strength. Further, the present invention provides a backup ring obtained by this manufacturing method and a seal structure for a fuel injection valve that uses this backup ring to improve sealability.

### Means for Solving the Problem

According to the present invention, there is provided a method of manufacturing a ring-shaped member that is manufactured by subjecting a rigid flat-shaped base material to burring and includes an open portion in its center, a flat portion that is disposed around the open portion, and a flange portion that is disposed between the open portion and the flat portion, overlaps the flat portion, and is raised in a perpendicular direction with respect to the flat portion, the method comprising: a step of forming a prepared hole with respect to the base material; a step of pressing an edge portion of the prepared hole to thereby bend the edge portion using a first punch member that has a diameter that is larger than the diameter of the prepared hole and is tapered towards its distal end portion; and a step of forming the flange portion by press-inserting, with respect to the prepared hole whose edge portion has been bent, a second punch member that has a diameter that is smaller than the diameter of the first punch member and is tapered towards its distal end portion, whereby the aforementioned problem can be solved.

Further, in implementing the method of manufacturing a ring-shaped member of the present invention, it is preferred that an angle of inclination θ1 of the tapered portion of the first punch member with respect to an axial line direction of the first punch member is larger than an angle of inclination θ2 of the tapered portion of the second punch member with respect to an axial line direction of the second punch member.

Further in implementing the method of manufacturing a ring-shaped member of the present invention, it is preferred that, when the thickness of the base material is t (mm), then the height of the flange portion of the ring-shaped member to be obtained is a value within the range of 1.5 t to 2.5 t (mm) and the thickness of the flange portion is a value within the range of 0.7 t to 0.9 t (mm).

Further, another aspect of the present invention is a backup ring that is used in a seal structure for a fuel passage having an annular seal member that is disposed in a pressure introduction chamber for sealing so that high-pressure fuel inside the pressure introduction chamber does not escape to a low pressure side from a gap formed between an injector housing and a valve body into which a valve piston has been slidably inserted, with the backup ring being disposed between the gap and the seal member and being for reinforcing the seal member, wherein the backup ring includes an open portion in its center, a flat portion that is disposed around the open portion, and a flange portion that is disposed between the open portion and the flat portion, overlaps the flat portion, and is raised in a perpendicular direction with respect to the flat portion, and the backup ring is manufactured by a method including forming a prepared hole with respect to a rigid base material, thereafter pressing an edge portion of the prepared hole to thereby bend the edge portion using a first punch member that has a diameter that is larger than the diameter of the prepared hole and is tapered towards its distal end portion, and then forming the flange portion by press-inserting, with respect to the prepared hole whose edge portion has been bent, a second punch member that has a diameter that is smaller than the diameter of the first punch member and is tapered towards its distal end portion.

Further, in configuring the backup ring of the present invention, it is preferred that, when the thickness of the base material is t (mm), then the height of the flange portion is a value within the range of 1.5 t to 2.5 t (mm) and the thickness of the flange portion is a value within the range of 0.7 t to 0.9 t (mm).

Further, in configuring the backup ring of the present invention, it is preferred that, when the thickness of the base material is a value within the range of 0.2 to 0.4 mm, then the height of the flange portion is a value within the range of 0.4 to 0.6 mm and the thickness of the flange portion is a value within the range of 0.15 to 0.35 mm.

Further, still another aspect of the present invention is a seal structure for a fuel injection valve having an annular seal member that is disposed in a pressure introduction chamber for sealing so that high-pressure fuel inside the pressure introduction chamber does not escape to a low pressure side from a gap formed between an injector housing and a valve body into which a valve piston has been slidably inserted, wherein the seal structure includes, between the gap and the seal member, a backup ring for reinforcing the seat member, the backup ring includes an open portion in its center, a flat portion that is disposed around the open portion, and a flange portion that is disposed between the open portion and the flat portion, overlaps the flat portion, and is raised in a perpendicular direction with respect to the flat portion, and the backup ring is manufactured by a method including forming a prepared hole with respect to a rigid base material, thereafter pressing an edge portion of the prepared hole to thereby bend the edge portion using a first punch member that has a diameter that is larger than the diameter of the prepared hole and is tapered towards its distal end portion, and then forming the flange portion by press-inserting, with respect to the prepared hole whose edge portion has been bent, a second punch member that has a diameter that is smaller than the diameter of the first punch member and is tapered towards its distal end portion.

Further, in configuring the seal structure for a fuel injection valve of the present invention, it is preferred that, when the thickness of the base material is t (mm), then the height of the flange portion is a value within the range of 1.5 t to 2.5 t (mm) and the thickness of the flange portion is a value within the range of 0.7 t to 0.9 t (mm).

Further, in configuring the seal structure for a fuel injection valve of the present invention, it is preferred that, when the thickness of the base material is a value within the range of 0.2 to 0.4 mm, then the height of the flange portion is a value within the range of 0.4 to 0.6 mm and the thickness of the flange portion is a value within the range of 0.15 to 0.35 mm.

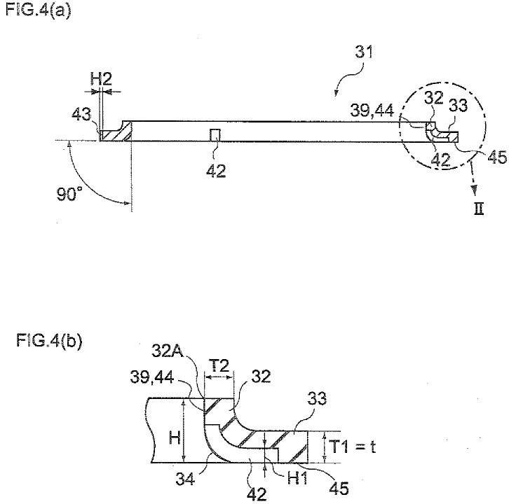

It will be noted that, throughout this specification, “height of the flange portion” means, as shown in FIG. 4(b), a perpendicular distance (H) from a bottom surface of a flat portion 33 in a state where a ring-shaped member 31 has been placed with a flange portion 32 facing up to an uppermost portion 32A of an inner peripheral surface of the flange portion 32 that is continuous with a curved portion 34.

### EFFECTS OF THE INVENTION

According to the method of manufacturing ring-shaped member of the present invention, by performing burring as a finishing process after bending the edge portion of the prepared hole a predetermined extent beforehand, both the thickness and height of the flange portion to be formed can be ensured even when the ring-shaped member is manufactured using a relatively thick base material. Consequently, a ring-shaped member that has excellent resistance to pressure and resistance to shock can be efficiently manufactured. It will be noted that a ring-shaped member with a predetermined shape can be more economically and efficiently manufactured in comparison also to when the ring-shaped member is manufactured by forging.

Further, according to the backup ring of the present invention and the seal structure for a fuel injection valve using the backup ring, the thickness of the flat portion is relatively thick, both the thickness and the height of the flange portion are ensured, its strength is improved, and extrusion of the seal member and stopping of the internal combustion engine accompanying that can be effectively prevented even when the fuel pressure is relatively high.

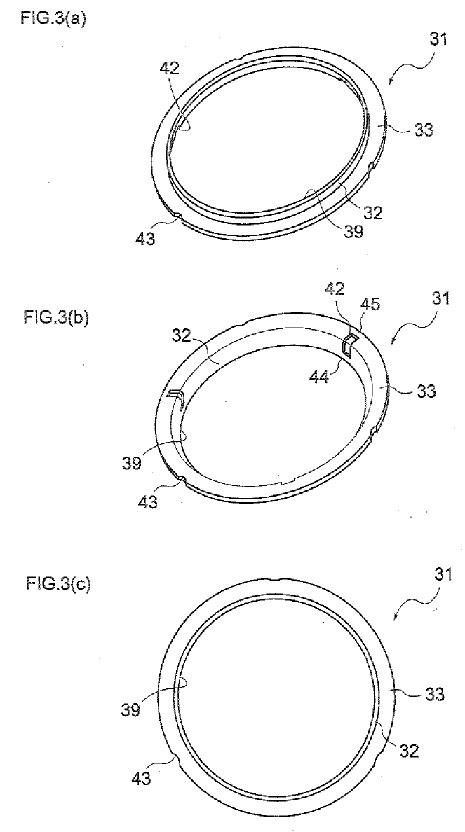

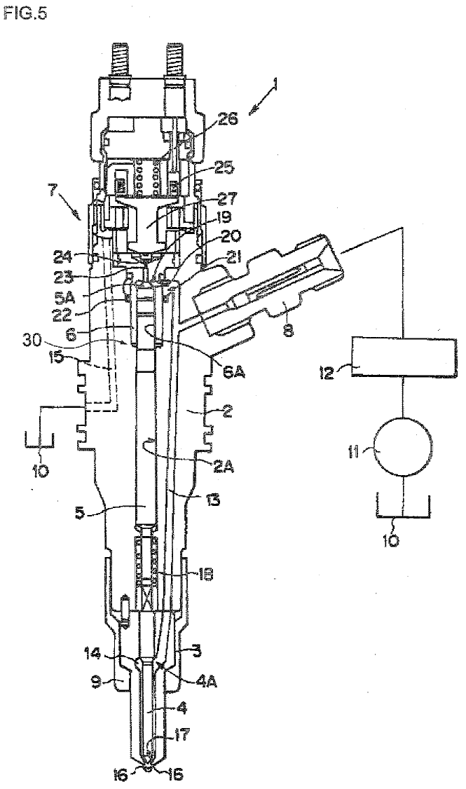

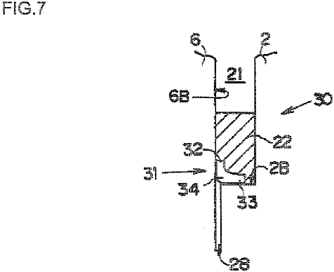

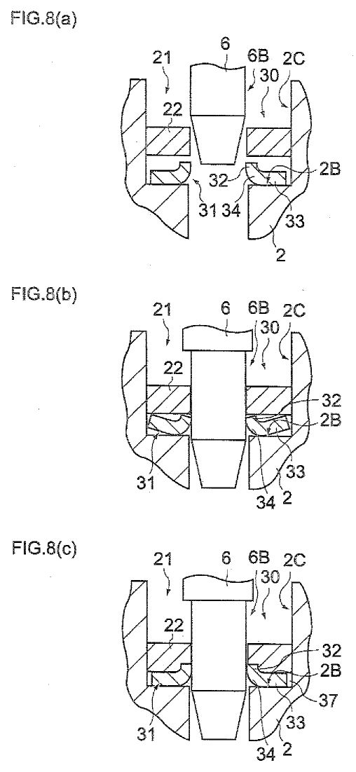

### BRIEF DESCRIPTION OF THE DRAWINGS

[FIG. 1] Diagrams (1) provided for describing a method of manufacturing ring-shaped member pertaining to a first embodiment.

[FIG. 2] Diagrams (2) provided for describing the method of manufacturing ring-shaped member pertaining to the first embodiment.

[FIG. 3] Perspective diagrams and a plan diagram of a backup ring pertaining to a second embodiment.

[FIG. 4] A cross-sectional diagram and a partially enlarged cross-sectional diagram of the backup ring.

[FIG. 5] A cross-sectional diagram of a fuel injection valve.

[FIG. 6] An enlarged cross-sectional diagram of relevant portions of a valve body and a back pressure control component in the fuel injection valve.

[FIG. 7] A partially enlarged cross-sectional diagram of a seal structure for fuel injection valve.

[FIG. 8] Enlarged cross-sectional diagrams showing a state where assembly of the fuel injection valve seal structure has been performed normally.

[FIG. 9] An enlarged cross-sectional diagram of relevant portions of a valve body and a back pressure control component of a conventional fuel injection valve.

### BEST MODES FOR IMPLEMENTING THE INVENTION

Below, embodiments relating to a method of manufacturing a ring-shaped member, a backup ring, and a seal structure for a fuel injection valve of the present invention will be specifically described with reference to the drawings. However, these embodiments represent one aspect of the present invention, are not intended to limit this invention, and may be arbitrarily altered within the scope of the present invention.

### First Embodiment

A first embodiment of the present invention is a method of manufacturing a ring-shaped member that is manufactured by subjecting a rigid flat-shaped base material to burring, with the ring-shaped member comprising an open portion in its center, a flat portion that is disposed around the open portion, and a flange portion that is disposed between the open portion and the flat portion, overlaps the flat portion, and is raised in a perpendicular direction with respect to the flat portion.

The method of manufacturing a ring-shaped member includes: a step of forming a prepared hole with respect to the base material; a step of pressing an edge portion of the prepared hole to thereby bend the edge portion using a first punch member that has a diameter that is larger than the diameter of the prepared hole and is tapered towards its distal end portion; and a step of forming the flange portion by press-inserting, with respect to the prepared hole whose edge portion has been bent, a second punch member that has a diameter that is smaller than the diameter of the first punch member and is tapered towards its distal end portion.

Below, a method of manufacturing a backup ring used in a seal structure for a fuel injection valve will be taken as an example and described in detail as the method of manufacturing a ring-shaped member.

1. Preparation Step

First, as shown in FIG. 1(a), a base material 51 of the ring-shaped member that becomes the backup ring is prepared. The base material 51 is a flat-shaped base material that comprises a rigid material such as steel and has a predetermined thickness; when the base material 51 is a base material used for manufacturing a backup ring as in the present embodiment, its thickness can be within the range of 0.2 to 0.4 mm, for example.

Further, it is preferred that the base material is a plate-shaped base material having a predetermined length so that plural backup rings can be continuously machined and manufactured. By implementing in this manner, later-described grooving, prepared hole punching, bending, and burring are performed while sequentially staggering the base material, whereby plural steps can be implemented at the same time with respect to different regions of the base material, so that plural backup rings can be efficiently manufactured.

2. Grooving Step

Next, as shown in FIG. 1(b), grooving is performed with respect to the base material 51. Grooves 42 formed in this grooving step become radial direction grooves 42 formed in the surface of the backup ring to be manufactured that is on a surface on the opposite side of the surface from which the flange portion is raised. As shown in FIG. 6, the radial direction grooves 42 are disposed so as to face a gap 28 on a low pressure side in a state where a backup ring 31 has been set inside a pressure introduction chamber 21 when the backup ring 31 is used in a fuel injection valve. Additionally, the radial direction grooves 42 have the function of allowing fuel leaking to the low pressure side over a seal member 22 and flowing into the radial direction grooves 42 via later-described thickness direction notch portions to quickly flow into the gap 28.

Here, the method of performing grooving with respect to the base material 51 is not particularly limited; for example, as shown in FIG. 1(b), the grooves can be formed by pressing the base material 51 with a punch member (sometimes called a “groove-use punch member”) 53 including a distal end portion that has been machined so as to conform to the groove shapes.

Further, the grooves 42 to be formed can be formed in plural places, such as three to four places, and in shapes along a circumferential direction in a peripheral portion when the base material is die-cut in a ring shape in the final step. Further, the grooves are machined such that they have a minimum depth H1, such as 0.5 mm or less for example, at which fuel can flow in the direction of the gap in order to ensure that the strength of the base material does not drop significantly as a result of forming the grooves.

3. Prepared Hole Forming Step

Next, as shown in FIG. 1(c), a prepared hole 55 is formed with respect to the base material 51 that has been grooved. The prepared hole 55 formed in this prepared hole forming step is a hole that becomes the basis for the open portion of the backup ring to be manufactured. Further, the prepared hole 55 is formed in the central portion of the region where the plural grooves 42 had been formed in the prior step.

The method of forming the prepared hole is not particularly limited; for example, as shown in FIG. 1(c), the prepared hole can be formed by pressing the base material with a punch member (sometimes called a “prepared hole-use punch member”) 57 that has been machined into a predetermined diameter and die-cutting part of the base material 51.

Here, the diameter of the prepared hole 55 to be formed (the diameter of the prepared hole-use punch member) can be determined in consideration of the size of the open portion of the backup ring to be manufactured and the height of the flange portion. That is, while it is necessary for the diameter of the prepared hole to be small in comparison to the diameter of the open portion of the backup ring, when the diameter of the prepared hole is significantly small, sometimes the edge portion of the prepared hole is extended excessively when the base material is subjected to burring and breakage occurs. Consequently, it is preferred that the diameter of the prepared hole to be formed is 0.90 r or greater with respect to the diameter (r) of the open portion of the backup ring to be manufactured.

4. Bending Step

Next, as shown in FIG. 2(a), with respect to the prepared hole 55 that has been formed, an edge portion 61 of the prepared hole 55 is pressed to thereby bend the edge portion 61 using a first punch member (sometimes called a “bending-use punch member”) 59 that has a diameter that is larger than the diameter of the prepared hole 55 and is tapered towards its distal end portion. By bending the edge portion 61 of the prepared hole 55 a predetermined extent beforehand at a stage prior to subjecting the base material to burring as a finishing process, the base material can be made easier to deform during burring even when the thickness of the base material is relatively thick.

More specifically, conventionally, when the prepared hole is directly subjected to burring in a case where the thickness of the base material is relatively thick, it is difficult for the base material to deform because the stress of the base material is large. For that reason, it is necessary to machine the base material while working (extending thin) the base material in order to ensure, to a certain extent, the height of the flange portion. That is, because the punch member used in burring is a punch member whose diameter corresponds to the diameter of the open portion to be formed and tries to form the flange portion at once, it is necessary to insert the punch member into the base material while gradually extending thin the edge portion of the prepared hole in order to ensure the height of the flange portion. When this happens, the thickness of the flange portion to be formed ends up becoming thin, so it becomes difficult to ensure the strength of the backup ring. Moreover, in extreme cases, breakage occurs in the vicinity of the upper portion of the flange portion.

Thus, in the method of manufacturing a ring-shaped member of the present invention, a predetermined bending step is implemented prior to the burring step, whereby the base material is made easier to deform, and the height and the thickness of the flange portion to be formed by burring in a later step can be ensured.

Here, in the bending step, as shown in FIG. 2(a), the edge portion 61 of the prepared hole 55 is pressed utilizing the tapered portion of the first punch member (bending-use punch member) 59 that has a diameter that is larger than the diameter of the prepared hole 55 and is tapered towards its distal end portion. By implementing in this manner, it becomes difficult for the first punch member to enter the prepared hole 55, and instances where the edge portion 61 of the prepared hole 55 is pulled no longer occur. Moreover, the angle of the edge portion 61 of the prepared hole 55 to be bent can also be regulated by the tapered angle of the distal end portion of the first punch member 59.

Further, in relation to the tapered shape of the distal end portion of the first punch member, it is preferred that the distal end portion has a tapered shape whose angle with respect to the axial line direction (X direction) of the first punch member is relatively large. The reason for this is so that the portion that becomes the flange portion can be bent without, as much as possible, causing it to deform (without it being extended thin). That is, when the angle with respect to the axial line direction of the punch member is small, it becomes easier for the punch member to be press-inserted into the prepared hole and, as a result, the edge portion of the prepared hole ends up being pulled, so the angle is made relatively large.

Consequently, it is preferred that the angle (θ1) of the tapered portion of the distal end portion of the first punch member 59 with respect to the axial line direction (X direction) of the first punch member 59 is a value within the range of 25 to 65 degrees, and more preferred that the angle is a value within the range of 30 to 50 degrees.

It will be noted that, in the method of manufacturing a backup ring of the present embodiment, as for the place of the edge portion 61 of the prepared hole 55 that is to be bent, bending is performed such that the grooves 42 formed in the prior grooving step correspond to the portion to be bent. Thus, when the backup ring is disposed in a fuel injection valve, fuel leaking from the high pressure side can be allowed to flow quickly to the low pressure side.

5. Burring Step

Next, as shown in FIG. 2(b), a flange portion 32 is formed by press-inserting, with respect to the prepared hole 55 whose edge portion 61 has been bent, a second punch member (sometimes called a “turning-use punch member”) 63 that has a diameter that is smaller than the diameter of the first punch member (bending-use punch member) 59 and is tapered towards its distal end portion. At this time, according to the method of a manufacturing ring-shaped member of the present invention, because the edge portion 61 of the prepared hole 55 has been bent beforehand, it becomes easier to deform the edge portion 61 so that burring can be performed easily. Consequently, because the flange portion 32 can be formed without pulling (extending thin) the edge portion 61 of the prepared hole 55 that has already been bent, the height of the flange portion 32 can be ensured, and the thickness of the flange portion 32 can also be maintained, even when the thickness of the base material is relatively thick.

Here, the diameter of the second punch member (burring-use punch member) 63 is configured to be equal to the diameter of the open portion of the backup ring to be formed. That is, by press-inserting and passing the second punch member 63 through the base material, the flange portion 32 is formed and an open portion 39 of a desired size is formed.

Further, it is preferred that the angle of inclination (θ2) of the tapered portion of the second punch member (burring-use punch member) 63 shown in FIG. 2(b) with respect to the axial line direction (X direction) of the second punch member is smaller than the angle of inclination (θ1) of the tapered portion of the first punch member (bending-use punch member) 59 shown in FIG. 2(a) with respect to the axial line direction (X direction) of the first punch member 59. The reason for this is to be able to make it easier to press-insert the second punch member 63 while pressing the edge portion 61 of the prepared hole 55 that has been bent beforehand.

Consequently, it is preferred that the angle of the tapered portion of the distal end portion of the second punch member 63 with respect to the axial line direction (X direction) of the second punch member 63 is a value within the range of 5 to 20 degrees, and more preferred that the angle is a value within the range of 10 to 15 degrees.

Further, as for the flange portion 32 formed in the burring step, for example, as shown in FIG. 4(b), when the thickness (T1) of the base material is t (mm), then it is suitable for the height (H) of the flange portion to be a value within the range of 1.5 t to 2.5 t (mm) and for the thickness (T2) of the flange portion to be a value within the range of 0.7 t to 0.9 t (mm). Conversely, in a case where the thickness of the base material is relatively thin, or in a case where the height of the flange portion of relatively low, or in a case where the thickness of the flange portion is relatively thin, a ring-shaped member of a predetermined shape can be manufactured by directly subjecting the base material to burring, but in a case where the thickness of the base material is relatively thick, or in a case where the relationship between the thickness of the base material and the height or thickness of the flange portion is the aforementioned relationship, it is difficult to deform the base material, so a predetermined flange portion can be formed efficiently by subjecting the base material to bending beforehand prior to performing burring.

6. Die-Cutting Step

Next, as shown in FIG. 2(c), with respect to the base material 51 in which has been formed the flange portion 32 whose thickness and height equal to or greater than predetermined values have been secured, die-cutting is performed using a punch member (die-cutting-use punch member) 65 whose shape corresponds to the outer shape of the backup ring 31. For example, the outer shape of the backup ring 31 (punch shape of the die-cutting-use punch member) is configured to have a size that is substantially equal to the size of the inner periphery of the injector housing of the fuel injection valve in which the backup ring is disposed.

Thus, as shown in FIGS. 3(a) to (c), there can be manufactured the backup ring 31 that includes the open portion 39 in its center, the flat portion 33 that is disposed around the open portion 39, and the flange portion 32 that is disposed between the open portion 39 and the flat portion 33, overlaps the flat portion 33, and is raised in a perpendicular direction with respect to the flat portion 33.

Further, in the method of manufacturing a backup ring of the present embodiment, when die-cutting is performed, it is preferred to perform die-cutting such that, as shown in FIG. 3(c), the outer shape includes plural recessed portions 43. The recessed portions 43 thus formed become the aforementioned thickness direction notch portions 43 and work with the radial direction grooves 42 to be able to allow fuel leaking from the high pressure side to quickly flow to the low pressure side when the backup ring is disposed in a fuel injection valve.

When the backup ring is manufactured as described above, the height of the flange portion can be ensured, and the thickness of the flange portion can be maintained in its thick state, even when the thickness of the flat portion has been made thick, so the backup ring can be made into one that has excellent strength which can withstand against a pressure of the high-pressure fuel.

### Second Embodiment

A second embodiment of the present invention is a seal structure for a fuel injection valve having an annular seal member that is disposed in a pressure introduction chamber for sealing so that high-pressure fuel inside the pressure introduction chamber does not escape to a low pressure side from a gap formed between an injector housing and a valve body into which a valve piston has been slidably inserted.

The seal structure for a fuel injection valve includes, between the gap and the seal member, a backup ring for reinforcing the seal member, the backup ring includes an open portion in its center, a flat portion that is disposed around the open portion, and a flange portion that is disposed between the open portion and the flat portion, overlaps the flat portion, and is raised in a perpendicular direction with respect to the flat portion, and the backup ring is manufactured by a method including forming a prepared hole with respect to a rigid base material, thereafter pressing an edge portion of the prepared hole to thereby bend the edge portion using a first punch member that has a diameter that is larger than the diameter of the prepared hole and is tapered towards its distal end portion, and then forming the flange portion by press-inserting, with respect to the prepared hole whose edge portion has been bent, a second punch member that has a diameter that is smaller than the diameter of the first punch member and is tapered towards its distal end portion.

1. Fuel Injection Valve and Seal Structure

First, a seal structure 30 for a fuel injection valve of the present embodiment will be described on the basis of FIG. 5 to FIG. 7. FIG. 5 is a cross-sectional diagram of a fuel injection valve 1, and FIG. 6 is an enlarged cross-sectional diagram of relevant portions of a valve body 6 and a back pressure control component 7 in the fuel injection valve 1 and shows the seal structure 30 for the fuel injection valve 1. Further, FIG. 7 shows an enlarged diagram of portion I of FIG. 6. The same reference numerals will be given to portions that are the same in the drawings, and description thereof will be appropriately omitted.

As show in FIG. 5, the fuel injection valve 1 can be configured by an injector housing 2, a nozzle body 3, a nozzle needle 4, a valve piston 5, a valve body 6, a back pressure control component 7, and a connecting rod 8.

The nozzle body 3 is attached by a nozzle nut 9 to the distal end portion of the injector housing 2, and the connecting rod 8 is attached to the upper portion of the injector housing 2. Additionally, high-pressure fuel that has been pressure-fed at a high pressure by a fuel pump 11 from a fuel tank 10 and accumulated in a common rail 12 (pressure accumulator) is supplied to the fuel injection valve 1 from the connecting rod 8. That is, a fuel passage 13 is formed from the connecting rod 8 towards the injector housing 2 and the nozzle body 3, and a fuel accumulation chamber 14 is formed facing a pressure-receiving component 4A of the nozzle needle 4. Moreover, part of the fuel passage 13 is extended upward in FIG. 5 from the connecting rod 8, whereby a fuel reflux passage (not shown) is formed from the back pressure control component 7 portion so that fuel is capable of being refluxed to the fuel tank 10.

Further, an arbitrary number of injection holes 16 is disposed in the distal end portion of the nozzle body 3, and the distal end portion of the nozzle needle 4 is seated on a seat component 17 connected to the fuel injection holes 16 so that the injection holes 16 are closed off. Additionally, when the nozzle needle 4 is lifted from the seat component 17, the injection holes 16 are opened so that fuel is capable of being injected.

Further, a nozzle spring 18 that energizes the nozzle needle 4 in the seating direction on the seat component 17 is disposed on the upper portion of the nozzle needle 4, and the valve piston 5 that is integrated with the nozzle needle 4 is extended further upward. The valve piston 5 is slidably inserted inside a sliding hole 2A in the injector housing 2 and a sliding hole 6A in the valve body 6.

Further, as shown in FIG. 6, a control pressure chamber 19 is formed in the upper central portion of the valve body 6, and the distal end portion of the valve piston 5 is allowed to face the control pressure chamber 19 from below. The control pressure chamber 19 is communicated with an introduction-side orifice 20 formed in the valve body 6. The introduction-side orifice 20 is communicated with the fuel passage 13 via a pressure introduction chamber 21 formed between the valve body 6 and the injector housing 2 and supplies pressure introduced from the common rail 12 to the control pressure chamber 19. A seal member 22 comprising a resin material, a rubber material, a copper material, or another soft material is disposed in the lower end portion of the pressure introduction chamber 21.

The control pressure chamber 19 is also communicated with an open/close-use orifice 23, and a valve ball 24 of the back pressure control component 7 is capable of opening and closing the open/close-use orifice 23. It will be noted that the pressure-receiving surface area of a top portion 5A of the valve piston 5 in the control pressure chamber 19 is made larger than the pressure-receiving surface area of the pressure-receiving component 4A (FIG. 5) of the nozzle needle 4.

Further, as shown in FIG. 5, the back pressure control component 7 includes a magnet 25, a valve spring 26, an armature 27, the valve ball 24 that is integrated with the armature 27, and the aforementioned control pressure chamber 19. A drive signal is supplied to the magnet 25, whereby the magnet 25 attracts the armature 27 counter to the energizing force of the valve spring 26, causes the valve ball 24 to be lifted from the open/close-use orifice 23, and enables release of pressure of the control pressure chamber 19 to the fuel reflux passage (not shown). Consequently, by operation of the valve bail 24, the pressure of the control pressure chamber 19 is controlled, the back pressure of the nozzle needle 4 is controlled via the valve piston 5, and sitting and lifting of the nozzle needle 4 is operated.

In the fuel injection valve 1 of this configuration, high-pressure fuel from the common rail 12 is supplied from the connecting rod 8 to the pressure-receiving component 4A of the nozzle needle 4 in the fuel accumulation chamber 14 via the fuel passage 13 and is supplied to the top portion 5A of the valve piston 5 in the control pressure chamber 19 via the pressure introduction chamber 21 and the introduction-side orifice 20. Consequently, the nozzle needle 4 receives the back pressure of the control pressure chamber 19 via the valve piston 5, is seated on the seat component 17 of the nozzle body 3 in conjunction with the energizing force of the nozzle spring 18, and closes off the injection holes 16.

In this state, the drive signal is supplied at a predetermined timing to the magnet 25, whereby the magnet 25 attracts the armature 27, and when the valve ball 24 opens up the open/close-use orifice 23, the high pressure of the control pressure chamber 19 refluxes to the fuel tank 10 through the fuel reflux passage (not shown) via the open/close-use orifice 23. When this happens, the high pressure that had acted on the top portion 5A of the valve piston 5 in the control pressure chamber 19 is released, the nozzle needle 4 is lifted by the high pressure of the pressure-receiving component 4A from the seat component 17 counter to the energizing force of the nozzle spring 18 to open up the injection holes 16, and fuel is injected.

On the other hand, when the valve ball 24 closes off the open/close-use orifice 23 as a result of the magnet 25 being demagnetized, the pressure inside the control pressure chamber 19 causes the nozzle needle 4 to be seated in its seated position (seat component 17) via the valve piston 5, close off the injection holes 16, and conclude fuel injection.

Here, the fuel pressure in the pressure introduction chamber 21 is equal to the injection pressure because it becomes positioned in an entrance portion leading to the control pressure chamber 19 that controls the fuel injection amount from the injection holes 16 and the injection period, and a high pressure that is equal to the injection pressure acts on the seal member 22. However, as shown in FIG. 6, a clearance that allows axial direction sliding of the valve piston 5 that integrally moves with the nozzle needle 4 is needed between the valve piston 5 and the valve body 6. When a structure is employed where the valve body 6 is press-inserted inside the injector housing 2, there is the potential for the valve body 6 to deform slightly inward and obstruct the sliding of the valve piston 5, so a slight clearance (gap) 28 is also disposed between the injector housing 2 and the valve body 6. For this reason, in the seal structure 30 for a fuel injection valve of the present invention, the backup ring 31 is disposed facing the gap 28 on the lower portion side (low pressure portion side) of the seal member 22 that is disposed in the bottom portion of the pressure introduction chamber 21. Thus, the backup ring 31 prevents instances where part of the seal member 22 ends up being pressed out in the gap 28 (low pressure side) between the injector housing 2 and the valve body 6 by the high pressure in the pressure introduction chamber 21.

In the seal structure 30 for a fuel injection valve of this configuration, the backup ring 31 includes a stopper function that retains the low pressure side portion (gap 28 side) of the seal member 22 and deters extrusion of the seal member 22 in the direction of the gap 28, and the seal function of the seal member 22 can be retained a long time and its durability and lifespan can be improved. Consequently, it is possible to more roughly design the tolerance of the gap 28 between the injector housing 2 and the valve body 6 than what has conventionally been the case, it becomes unnecessary to make strict the parts accuracy and assembly accuracy of the seal member 22, the backup ring 31, the injector housing 2 and the valve body 6, and the seal structure can be manufactured more inexpensively than what has conventionally been the case.

2. Backup Ring

Next, the backup ring used in the seal structure for a fuel injection valve of the present embodiment will be described in detail.

As shown in FIG. 7, the backup ring 31 comprises the open portion in its center through which the valve body is inserted in the pressure introduction chamber 21, the flat portion 33 that is disposed around the open portion and is along an inner wall step portion 2B of the injector housing 2, and the flange portion 32 that is disposed between the open portion and the flat portion, overlaps the flat portion 33, extends diametrically in a right angle with respect to the flat portion 33, and is along an outer peripheral surface 6B of the valve body 6. That is, the flange portion 32 abuts against the outer peripheral surface 6B of the valve body 6, and the flat portion 33 abuts against the inner peripheral surface (inner wall step portion 2B) of the injector housing 2 in the pressure introduction chamber 21, assists the seal function, and holds the seal member 22 such that the seal member 22 is not pressed out towards the gap 28.

Here, the backup ring 31 used in a sealing structure 30 for the fuel injection valve in the present embodiment is the backup ring 31 manufactured by the method of manufacturing a ring-shaped member of the preceding first embodiment. That is, the backup ring is manufactured by a method including forming a prepared hole with respect to a rigid base material, thereafter pressing an edge portion of the prepared hole to thereby bend the edge portion using a first punch member that has a diameter that is larger than the diameter of the prepared hole and is tapered towards its distal end portion, and then forming the flange portion by press-inserting, with respect to the prepared hole whose edge portion has been bent, a second punch member that has a diameter that is smaller than the diameter of the first punch member and is tapered towards its distal end portion.

Consequently, the thickness of the flat portion 33 can be made thicker in comparison to that of a conventional backup ring and both the height and the thickness of the flange portion 32 are ensured a predetermined extent or greater, so the backup ring 31 has excellent strength. Thus, even when the pressure of fuel sent from a common rail or the like is high, it is difficult for the backup ring to break, and the seal member 22 is not pressed out into the gap.

FIG. 3(a) shows a perspective diagram of the backup ring 31, FIG. 3(b) shows a perspective diagram of the backup ring 31 as seen from its backside, and FIG. 3(c) shows a plan diagram of the backup ring 31. Further, FIG. 4(a) shows a cross-sectional diagram of the backup ring 31, and FIG. 4(b) shows an enlarged cross-sectional diagram of portion II of FIG. 4(a).

As shown in these drawings, the backup ring 31 includes the flange portion 32 and the flat portion 33, and the radial direction grooves 42 axe formed in several places (in the examples shown in the drawings, at three places at intervals of 120 degrees) from the flat portion 33 towards the flange portion 32. In particular, as shown in FIG. 3(b), the radial direction grooves 42 are formed from the bottom surface of the flat portion 33 towards the bottom surface of a curved portion 34, and a flat abutment portion 44 that abuts against the outer peripheral surface 6B of the valve body 6 is left on the upper end portion of the flange portion 32. Further, a flat portion is also left on the peripheral edge portion of the flat portion 33. Further, the arc-shaped thickness direction notch portions 43 are formed in positions in the outer peripheral portion of the flat portion 33 that do not overlap the radial direction grooves 42.

In this backup ring 31, the radial direction grooves 42 face the gap 28 on the low pressure side when the backup ring 31 has been set inside the pressure introduction chamber 21, and the radial direction grooves 42 have a minimum depth H1, such as 0.5 mm or less for example, at which fuel can flow in the direction of the gap 28. The thickness direction notch portions 43 ensure that fuel crossing over the seal member 22 and leaking to the low pressure side is allowed to seep towards the bottom surface of the backup ring 31 via the thickness direction notch portions 43 and flows to the radial direction grooves 42, and the notch length H2 in the radial direction thereof is also a necessary minimum. The flat abutment portion 44 imparts a seal function to the backup ring 31 itself such that fuel does not leak out from the portion where the backup ring 31 and the valve body 6 contact each other, and the necessary axial direction length (height of the flange portion) is ensured. By disposing a flat portion 45 and ensuring that the thickness direction notch portions 43 and the radial direction grooves 42 do not overlap, it is ensured that fuel does not flow excessively.

For example, as for the backup ring 31, when the thickness (T1) of the flat portion (base material) 33 is t (mm), then it is suitable for the height (H) of the flange portion 32 to be a value within the range of 1.5 t to 2.5 t (mm) and for the thickness (T2) of the flange portion 32 to be a value within the range of 0.7 t to 0.9 t (mm). With this backup ring 31, even when the thickness of the flat portion 33 is thick, the height (H) of the flange portion 32 can be made relatively high and the thickness (T2) of the flange portion 32 can be ensured relatively thickly, so the reinforcing performance of the seal member can be improved.

More specifically, as for the backup ring 31 of the present invention, it is preferred that the thickness of the base material is a value within the range of 0.2 to 0.4 mm, the height of the flange portion is a value within the range of 0.4 to 0.6 mm, and the thickness of the flange portion is a value within the range of 0.15 to 0.35 mm. With this backup ring, the backup ring can be used in a fuel injection valve as a strong backup ring without having to greatly change the internal structure of the fuel injection valve.

It will be noted that, in the backup ring 31, because the curved portion 34 is formed from the flat portion 33 towards the flange portion 32, an elastic force can be generated where the seal member 22 that is pressed by the high pressure of the pressure introduction chamber 21 and elastically deformed by the backup ring 31 energizes the flange portion 32 of the backup ring 31 in the direction of the outer peripheral surface 6B of the valve body 6, so that the seal function can be raised.

Moreover, because the aforementioned seal structure 30 can be employed, it becomes possible to enlarge the clearance of the gap 28 between the injector housing 2 and the valve body 6, and even when the injector housing 2 is somewhat deformed by external force, it becomes difficult for the affect of that deformation to extend to the valve body 6, the clearance between the valve body 6 and the valve piston 5 is maintained as designed, and there is no longer the potential for the sliding of the valve piston 5 to be impaired.

Next, FIGS. 8(a) to (c) show enlarged cross-sectional diagrams of relevant portions of the seal member 22 and the backup ring 31 portion when assembly of the seal structure 30 for a fuel injection valve (FIG. 5 or FIG. 6) has been performed normally.

As shown in FIG. 8(a), the valve body 6 is inserted from centrally above in a state where the backup ring 31 has been set on the inner wall step portion 2B of the injector hosing 2 and the seal member 22 has been set thereon. Next, as shown in FIG. 8(b), the backup ring 31 plastically deforms such that the circumferential side portion of the flat portion 33 thereof rises from the inner wall step portion 2B because of the action of friction between the valve body 6, the seal member 22 and the backup ring 31 as a result of inserting and setting the valve body 6. Next, as shown in FIG. 8(c), during an ordinary operating state of the fuel injection valve 1, high-pressure fuel fills the pressure introduction chamber 21, the seal member 22 and the backup ring 31 are pressed by the pressure thereof against the outer peripheral surface 613 of the valve body 6, the inner wall step portion 2B of the injector housing 2 and a pressure introduction chamber side inner wall surface 2C and are maintained in a set state in which they fulfill their seal function.

In this set state, the flange portion 32 of the backup ring 31 abuts against the outer peripheral surface 6B of the valve body 6, the flat portion 33 abuts against the inner wall step portion 23 of the injector housing 2, a slight void portion 37 is formed between the pressure introduction chamber side inner wall surface 2C of the injector housing 2 and the end portion of the flat portion 33, and there is no trouble whatsoever during normal operation of the fuel injection valve 1.

In the seal structure 30 for a fuel injection valve of this configuration, the pressure introduction chamber 21 on the high pressure side and the gap 28 on the low pressure side are mutually sealed by the seal member 22 and the backup ring 31, but it is difficult to completely prevent the fuel of the pressure introduction chamber 21 from crossing over the seal member 22 and slightly leaking towards the backup ring 31. However, it is possible for fuel leaking from the pressure introduction chamber 21 to flow out towards the gap 28 because of the thickness direction notch portions 43 and the radial direction grooves 42, and a portion where fuel accumulates is no longer formed between the seal member 22 and the backup ring 31.

In this manner, by forming the thickness direction notch portions 43 and the radial direction grooves 42 in the backup ring 31, the backup ring 31 is given a drain function where fuel can actively flow to the low pressure side a little at a time. Consequently, the seal function of the seal member 22 and the support function of the backup ring 31 can be stabilized and their life spans can be displayed for a long time.

1-9. (canceled)

10. A method of manufacturing a ring-shaped member that is manufactured by subjecting a rigid flat-shaped base material to burring and includes an open portion in its center, a flat portion that is disposed around the open portion, and a flange portion that is disposed between the open portion and the flat portion, overlaps the flat portion, and is raised in a perpendicular direction with respect to the flat portion, the method comprising the steps of:
forming a prepared hole through to the base material;
pressing an edge portion of the prepared hole to thereby bend the edge portion using a first punch member that has a diameter that is larger than the diameter of the prepared hole and is tapered towards its distal end portion; and
forming the flange portion by press-inserting, with respect to the prepared hole whose edge portion has been bent, a second punch member that has a diameter that is smaller than the diameter of the first punch member and is tapered towards its distal end portion.

11. The method of manufacturing a ring-shaped member as defined in claim 10, wherein an angle of inclination θ1 of the tapered portion of the first punch member with respect to an axial line direction of the first punch member is larger than an angle of inclination θ2 of the tapered portion of the second punch member with respect to an axial line direction of the second punch member.

12. The method of manufacturing a ring-shaped member as defined in claim 10, wherein when the thickness of the base material is t, then the height of the flange portion of the ring-shaped member to be obtained is a value within the range of 1.5 t to 2.5 t and the thickness of the flange portion is a value within the range of 0.7 t to 0.9 t.

13. The method of manufacturing a ring-shaped member as defined in claim 11, wherein when the thickness of the base material is t, then the height of the flange portion of the ring-shaped member to be obtained is a value within the range of 1.5 t to 2.5 t and the thickness of the flange portion is a value within the range of 0.7 t to 0.9 t.

14. A backup ring that is used in a seal structure for a fuel passage having an annular seal member that is disposed in a pressure introduction chamber for sealing so that high-pressure fuel inside the pressure introduction chamber does not escape to a low pressure side from a gap formed between an injector housing and a valve body into which a valve piston has been slidably inserted, with the backup ring being disposed between the gap and the seal member and being for reinforcing the seal member,
wherein
the backup ring includes an open portion in its center, a flat portion that is disposed around the open portion, and a flange portion that is disposed between the open portion and the flat portion, overlaps the flat portion, and is raised in a perpendicular direction with respect to the flat portion, and
wherein the backup ring is manufactured by a method including forming a prepared hole through a rigid base material, thereafter pressing an edge portion of the prepared hole to thereby bend the edge portion using a first punch member that has a diameter that is larger than the diameter of the prepared hole and is tapered towards its distal end portion, and then forming the flange portion by press-inserting, with respect to the prepared hole whose edge portion has been bent, a second punch member that has a diameter that is smaller than the diameter of the first punch member and is tapered towards its distal end portion.

15. The backup ring of claim 14, wherein when the thickness of the base material is t, then the height of the flange portion is a value within the range of 15 t to 2.5 t and the thickness of the flange portion is a value within the range of 0.7 t to 0.9 t.

16. The backup ring of claim 14, wherein when the thickness of the base material is a value within the range of 0.2 to 0.4 mm, then the height of the flange portion is a value within the range of 0.4 to 0.6 mm and the thickness of the flange portion is a value within the range of 0.15 to 0.35 mm.

17. The backup ring of claim 15, wherein when the thickness of the base material is a value within the range of 0.2 to 0.4 mm, then the height of the flange portion is a value within the range of 0.4 to 0.6 mm and the thickness of the flange portion is a value within the range of 0.15 to 0.35 mm.

18. A seal structure for a fuel injection valve having an annular seal member that is disposed in a pressure introduction chamber for sealing so that high-pressure fuel inside the pressure introduction chamber does not escape to a low pressure side from a gap formed between an injector housing and a valve body into which a valve piston has been slidably inserted,
wherein
the seal structure includes, between the gap and the seal member, a backup ring for reinforcing the seal member,
the backup ring includes an open portion in its center, a flat portion that is disposed around the open portion, and a flange portion that is disposed between the open portion and the flat portion, overlaps the flat portion, and is raised in a perpendicular direction with respect to the flat portion, and
the backup ring is manufactured by a method including forming a prepared hole through a rigid base material, thereafter pressing an edge portion of the prepared hole to thereby bend the edge portion using a first punch member that has a diameter that is larger than the diameter of the prepared hole and is tapered towards its distal end portion, and then forming the flange portion by press-inserting, with respect to the prepared hole whose edge portion has been bent, a second punch member that has a diameter that is smaller than the diameter of the first punch member and is tapered towards its distal end portion.

19. The seal structure for a fuel injection valve of claim 18 wherein when the thickness of the base material is t, then the height of the flange portion is a value within the range of 1.5 t to 2.5 t and the thickness of the flange portion is a value within the range of 0.7 t to 0.9 t.

20. The seal structure for a fuel injection valve of claim 18, wherein when the thickness of the base material is a value within the range of 0.2 to 0.4 mm, then the height of the flange portion is a value within the range of 0.4 to 0.6 mm and the thickness of the flange portion is a value within the range of 0.15 to 0.35 mm.

21. The seal structure for a fuel injection valve of claim 19, wherein when the thickness of the base material is a value within the range of 0.2 to 0.4 mm, then the height of the flange portion is a value within the range of 0.4 to 0.6 mm and the thickness of the flange portion is a value within the range of 0.15 to 0.35 mm.
